(19) United States
(12) Patent Application Publication
(10) Pub. No.: US 2009/0096657 A1
(43) Pub. Date: Apr. 16, 2009

(54) REMOTE CONTROL UNIT FOR OPERATING AN ELECTRONIC DEVICE

(75) Inventors: Yen-Tsun LIN, Gueishan Hsiang (TW); Cheng-Te Tseng, Gueishan Hsiang (TW); Tson-Yee Lin, Gueishan Hsiang (TW); Chen-Cheng Chiang, Gueishan Hsiang (TW)

Correspondence Address: BIRCH STEWART KOLASCH & BIRCH, PO BOX 747, FALLS CHURCH, VA, 22040-0747, US

(73) Assignee: Qisda Corporation, Gueishan Hsiang (TW)

(21) Appl. No.: 12/185,528

(22) Filed: Aug. 4, 2008

(30) Foreign Application Priority Data
Oct. 12, 2007 (TW) 96138311

(51) Int. Cl. G08C 19/00

(52) U.S. Cl. 341/176

(57) ABSTRACT

A remote control unit includes a housing, at least one pushbutton, a signal transmitter and a detection circuit. The pushbutton is disposed on the housing. The signal transmitter is mounted rotatably on the housing and capable of being switched between first and second positions. The detection circuit is coupled electrically to the pushbutton and the signal transmitter for generating a control signal upon detecting activation of the pushbutton. The signal transmitter transmits a first function signal when the signal transmitter is disposed at the first position and a second function signal different from the first function signal when the signal transmitter is disposed at the second position.

### FIELD OF THE INVENTION

The present invention relates to a remote control unit, more particularly to a remote control unit that is capable of transmitting different function signals when disposed at different positions with respective to an electronic device in order to control the functions of the electronic device.

### BACKGROUND OF THE INVENTION

In our daily life, a remote control unit is usually applied in order to facilitate the user to operate or control a predetermined function of an electronic apparatus or device. The remote control unit generally includes a signal transmitter and a plurality of buttons or keys each corresponding to a function signal. When the user activates one of the buttons, a function signal corresponding to the respective button is transmitted via the signal transmitter to the electronic device, thereby performing a predetermined task (i.e. switch on/off the TV set or changing the channel).

In actual practice, when the aforesaid remote control unit is used for controlling or activating predetermined functions in several electronic apparatus, the same unit may transmit the function signals along different routes due to different holding habits or hand-gripping of the user. Generally, two signal transmitters are provided at two different positions of the remote control unit for transmitting the signal in different routes. According to U.S. Pat. No. 6,794,992B1, a remote control unit is disclosed to have two signal transmitters for transmitting signals in different directions.

Referring to FIG. 1 of the cited patent, the remote control unit 1 includes a housing 11, a plurality of buttons 12, a first signal transmitter 13, a second signal transmitter 14 and a mode switch 15. The buttons 12 are disposed on the housing 12. Each button is corresponding to a first function signal belonging to a first function group and a second function signal belonging to a second function group. The first and second signal transmitters 13, 14 are mounted on the housing 21 to extend along first and second directions S0, S0′. The mode switch 15 is movable on the housing 11 between first and second positions P1, P2.

When the user holds the remote control unit 1 to extend in the first direction I0 with respect to the electronic device (not shown) and after moving the mode switch 15 to the first position P1, the user can operate at least one predetermined task according to a first function signal. Activation of any one of the buttons 12 can permit the first signal transmitter 13 to transmit the first function signal S0 belonging to the first function group along the first direction I0.

When the user holds the remote control unit 1 to extend in the second direction I0′ with respect to the electronic device (not shown) and after moving the mode switch 15 to the second position P2, the user can operate at least one predetermined task according to a second function signal. Activation of any one of the buttons 12 can permit the second signal transmitter 14 to transmit a second function signal S0′ belonging to the second function group along the second direction I0′.

In another application, the user can grip the remote control unit 1 in another way in such a manner that the second signal transmitter 14 extends along the first direction I0. Under this condition, if the mode switch 15 is shifted to the first position P1 and activation of any one of the buttons 12 will allow the second signal transmitter 14 to transmit a first function signal S0 corresponding to the respective button along the first direction I0, thereby operating the predetermined task of the electronic device.

In contrast, when the mode switch 15 is shifted to the second position P2 and in case of activation of any one of the buttons 12, the second signal transmitter 14 can transmit a second function signal S0′ corresponding the respective button along the first direction I0, thereby operating the predetermined task defined by the second function.

Two problems arise when the aforesaid remote control unit is utilized to operate the functions of the electronic device.

(1) Employment of two spaced apart signal transmitters 13, 14 result in material waste and extra manufacturing cost;

(2) In actual practice, the first and second function signals S0, S0′ generated by activation of the buttons 12 are interrelated to one another, for instance, gripping or holding position of the hands on the remote control unit, the position of the mode switch 15, and the first and second function signals S0, S0′ transmitted by the first and second signal transmitters 13, 14. The user may lead to confusion whether the first or second function signal S0, S0′ transmitted by the remote control unit is used for operating what type of predetermined tasks defined by the first or second function groups.

### SUMMARY OF THE INVENTION

The first object of the present invention to provide a remote control unit including at least one pushbutton and a signal transmitter, which position is changeable between different positions for defining the function signal representing the button. A single signal transmitter is implemented in the remote control unit so as to be ergonomic to the gripping habits of the user for transmitting the signal of different function from different angles.

Another object of the present invention is to provide a remote control unit having the feature that when the control signal transmitted by the signal transmitter is unable to provide directive properties, thereby failing to operate the predetermined task in the electronic device, a function signal having the directive properties and representing a respective pushbutton can be defined by the user's holding position of the remote control unit.

In one aspect of the present invention, a remote control unit is provided to include a housing, at least one pushbutton, a signal transmitter and a detection circuit. The pushbutton is disposed on the housing. The signal transmitter is mounted rotatably on the housing and capable of being switched between first and second positions. The detection circuit is coupled electrically to the pushbutton and the signal transmitter for detecting the activation of the pushbutton. The detection circuit activates the signal transmitter to output a function signal. The signal transmitter transmits a first function signal when the signal transmitter is disposed at the first position and a second function signal different from the first function signal when the signal transmitter is disposed at the second position.

In a second aspect of the present invention, a remote control unit is provided to include a housing, at least one pushbutton, a signal transmitter and a detection circuit. The housing defines a longitudinal axis. The pushbutton is disposed on the housing and is capable of generating a first function signal and a second function signal different from the first function signal. The signal transmitter is mounted on the housing and is capable of transmitting the first and second function signals upon the activation of the pushbutton. The detection circuit is coupled electrically to the pushbutton and the signal transmitter for detecting whether the longitudinal axis extends in a first direction or a second direction. The signal transmitter transmits the first function signal and the second function signal respectively upon detecting the longitudinal axis extending along the first and second directions. The remote control unit further comprises a function circuitry coupled electrically to the detection circuit for defining a first function group for the first function signal when the signal transmitter is at the first position and a second function group for the second function signal when the signal transmitter is at the second position. The function circuitry preferably includes a first function circuit and a second function circuit respectively defining the first function group and the second function group. The first direction is perpendicular to the second direction.

When compared with the prior art remote control unit, the remote control unit of the present invention provides the following features:

(1) when the function signal generated due to the activation of one of the pushbuttons and transmitted by the signal transmitter of the present remote control unit at the presently located position possesses the directive properties, the same can operate a predetermined task of the electronic device;

(2) in the event, the function signal generated due to the activation of one of the pushbuttons and transmitted by the signal transmitter of the present remote control unit at the presently located position fail to possesses the directive properties, thereby rendering the function signal unable to operate a predetermined task of the electronic device. A function signal having the directive properties can be defined for the respective pushbutton by the user's gripping position of the remote control unit of the present invention. Only a single signal transmitter is implemented in the remote control unit of the present invention so as to be ergonomic to the gripping habits of the user for transmitting the signal of different functions from different angles.

Since a single signal transmitter is implemented in the remote control unit of the present invention when compared to two signal transmitters in the prior art remote control unit, the material and manufacturing cost thereof can be economized. In addition, the user does not memorize several switching modes so as to facilitate the user to handle the remote control unit with ease and convenience.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows a prior art remote control unit;

FIG. 2 is a perspective view of the first embodiment of a remote control unit of the present invention;

FIG. 3 is a block diagram illustrating the elements of the first embodiment of the remote control unit of the present invention;

FIGS. 4A to 4C respectively show the first embodiment of the remote control unit of the present invention transmits different function signals when the signal transmitter is disposed at different directive positions;

FIG. 5 is a block diagram illustrating the elements of the second embodiment of the remote control unit of the present invention; and

FIGS. 6A and 6B respectively show the second embodiment of the remote control unit of the present invention transmits different function signals when the same is gripped by the user in different ways.

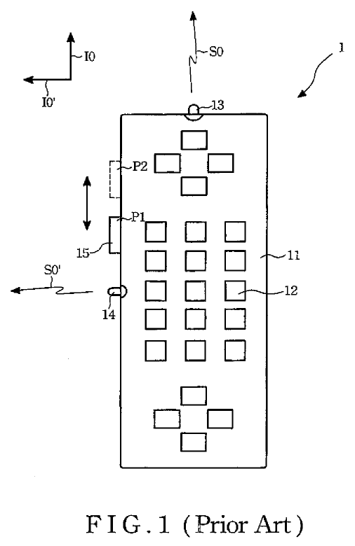

### DEICED DESCRIPTIONS OF THE PREFERRED EMBODIMENTS

The signal transmitter in the remote control unit of the present invention is designed ergonomically to facilitate the gripping habits of a user in different ways and its extending direction can be switched to other direction so as to control or operate several electronic devices (like TV set, Video games, Air conditioner etc.). Its structure should not be limited to only one embodiment.

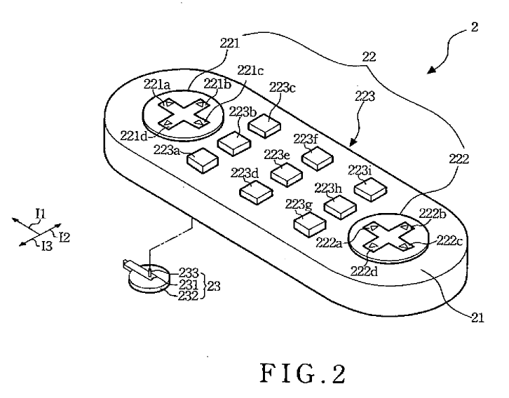

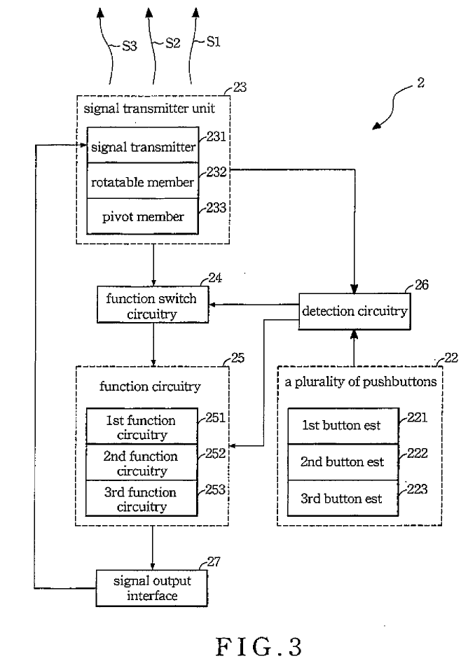

Referring to FIGS. 2 and 3, the first embodiment of the remote control unit 2 of the present invention is shown to include a housing 21, a plurality of pushbuttons 22, a signal transmitter unit 23, a function switch circuitry 24, a function circuitry 25, a detection circuit 26 and a signal output interface 27.

The pushbuttons 22 are disposed on the housing 21 in a known manner, and are grouped into a first button set 221, a second button set 222 and a third button set 223. The first button set 221 consists of four buttons 221a, 221b, 221c and 221d arranged together in a cross manner adjacent to one end of the housing 21. The second button set 222 consists of four buttons 222a, 222b, 222c and 222d arranged together in a cross manner adjacent to the other end of the housing 21. The third button set 223 consists of nine buttons 223a, - - - , 223i distributed evenly on the housing 21 between the first and second sets 221, 222.

The first, second and third button sets 221, 222 and 223 respectively correspond to first, second and third function groups. Thus, each button 221a, 221b, 221c and 221d in the first button set 221 provides a first function, each button 222a, 222b, 222c and 222d in the second button set 222 provides a second function, while each button 223a, - - - , 223i in the third button set 223 provides a third function.

The signal transmitter unit 23 is mounted rotatably on the housing 21, and includes a signal transmitter 231, a rotatable member 232 and a pivot member 233. The signal transmitter 231 is disposed on the rotatable member 232, which, in turn, is attached to the housing 21 via the pivot member 233 in such a manner that the rotatable member 232 is pivotable about the pivot member 233 so as to dispose the signal transmitter 231 to extend along a first direction I1, a second direction I2 and a third direction I3, wherein the first direction I1 is perpendicular to the second direction I2. In other words, the signal transmitter 231 is capable of being switched among the first, second and third positions.

The function switch circuitry 24 is coupled electrically to the signal transmitter unit 23. The function circuitry 25 is coupled electrically to the buttons 221a-221d, 222a-222d, 223a - - - 223i and the function switch circuitry 24, further includes a first function circuit 251, a second function circuit 252 and a third function circuit 253 respectively corresponding to the first function group, the second function group and the third function group. The detection circuit 26 is coupled electrically to the pushbuttons 22, the signal transmitter unit 23, the function switch circuitry 24 and the function circuitry 25. The signal output interface 27 is coupled to the signal transmitter unit 23 and the detection circuit 26.

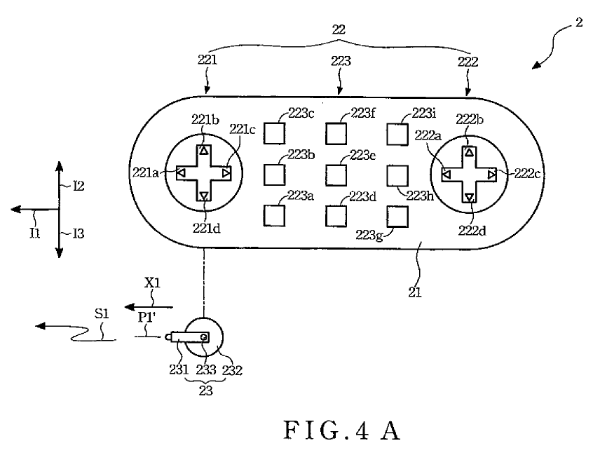

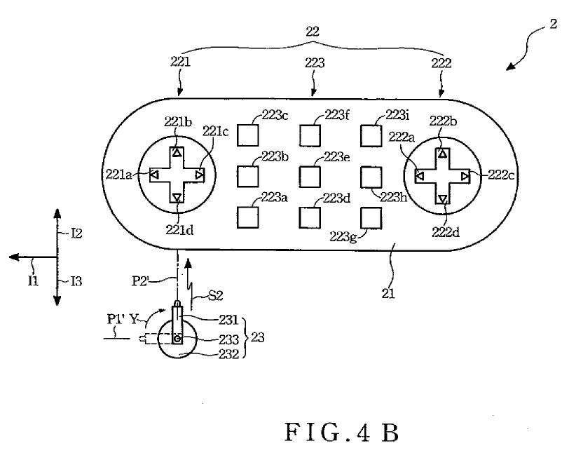

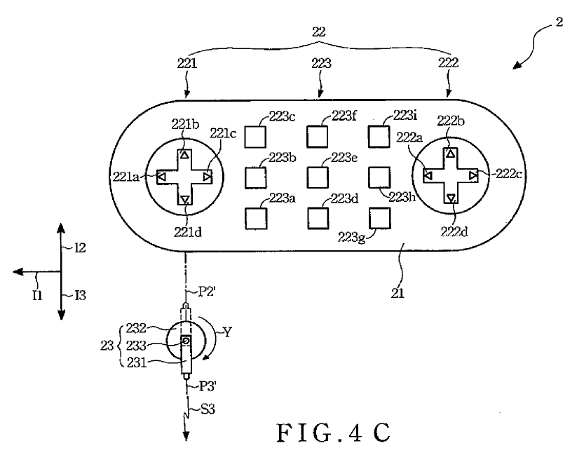

FIGS. 4A to 4C respectively show the first embodiment of the remote control unit 2 of the present invention transmits different function signals when the signal transmitter 231 is disposed at different directive positions (i.e., different positions). As illustrated in FIGS. 3 and 4A, when shifted to the first position P1′ , the signal transmitter 231 extends along the first direction I1. At this time, the detection circuit 26 is capable of detecting that the signal transmitter 231 extends along the first direction I1 and activates the first function circuit 251 via the function switch circuitry 24.

When the detection circuit 26 detects of activation of any one of the buttons 221a-221d, 222a-222d, 223a - - - 223i, the first function circuit 251 generates the first function signal of the first function group and that the first function signal is conveyed to the signal transmitter 231 via the signal output interface 27. The signal transmitter 231 transmits the first function signal S1 along the first direction I1 to the electronic device (not shown), thereby performing a predetermined task representing the first function signal.

Referring to table 1, when the detection circuit 26 detects of activation of the button 223a, the first function circuit 251 generates the first function A of the first function group, which is later conveyed via the signal output interface 27 to the signal transmitter 231. Thus, the signal transmitter 231 transmits the first function signal S1 along the first direction I1 to the electronic device (not shown), thereby performing a predetermined task representing the first function A.

TABLE 1
the first function group [with ref: to FIG. 4A]

| | Element No | | | | | | | |
|---|---|---|---|---|---|---|---|---|
| | 221a | 221b | 221c | 221d | 222a | 222b | 222c | 222d |
| 1^{st}. | A | B | C | D | E | F | G | H |
| function | | | | | | | | |

| | Element No | | | | | | | | |
|---|---|---|---|---|---|---|---|---|---|
| | 223a | 223b | 223c | 223d | 223e | 223f | 223g | 223h | 223i |
| 1^{st} | I | J | K | L | M | N | O | P | Q |
| function | | | | | | | | | |

As illustrated in FIGS. 3 and 4B, when the rotatable member 232 is shifted along the Y direction from the first position P1′ to the second position P2′ , the signal transmitter 231 extends along the second direction I2. At this time, the detection circuit 26 is capable of detecting that the signal transmitter 231 extends along the second direction I2 and activates the second function circuit 252 via the function switch circuitry 24.

When the detection circuit 26 detects of activation of any one of the buttons 221a-221d, 222a-222d, 223a - - - 223i, the second function circuit 252 generates the second function signal of the second function group and that the second function signal is conveyed to the signal transmitter 231 via the signal output interface 27. The signal transmitter 231 transmits the second function signal S2 along the second direction I2 to the electronic device (not shown), thereby performing the predetermined task representing the second function signal.

Referring to table 2, when the detection circuit 26 detects of activation of the button 223a, the second function circuit 252 generates the second function O of the second function group, which is later conveyed via the signal output interface 27 to the signal transmitter 231. Thus, the signal transmitter 231 transmits the second function signal S2 along the second direction I2 to the electronic device (not shown), thereby performing the predetermined task representing the second function O.

TABLE 2
the second function group [with ref: to FIG. 4B]

| | Element No | | | | | | | |
|---|---|---|---|---|---|---|---|---|
| | 221a | 221b | 221c | 221d | 222a | 222b | 222c | 222d |
| 2^{nd}. | D | A | B | C | H | E | F | G |
| function | | | | | | | | |

| | Element No | | | | | | | | |
|---|---|---|---|---|---|---|---|---|---|
| | 223a | 223b | 223c | 223d | 223e | 223f | 223g | 223h | 223i |
| 2^{nd} | O | L | I | P | M | J | Q | N | K |
| function | | | | | | | | | |

As illustrated in FIGS. 3 and 4C, when the rotatable member 232 is shifted along the Y direction from the second position P2′ to the third position P3′ , the signal transmitter 231 extends along the third direction I3. At this time, the detection circuit 26 is capable of detecting that the signal transmitter 231 extends along the third direction I3 and activates the third function circuit 253 via the function switch circuitry 24.

When the detection circuit 26 detects of activation of any one of the buttons 221a-221d, 222a-222d, 223a - - - 223i, the third function circuit 252 generates the third function signal of the third function group and that the third function signal is conveyed to the signal transmitter 231 via the signal output interface 27. The signal transmitter 231 transmits the third function signal S3 along the third direction I3 to the electronic device (not shown), thereby performing the predetermined task representing the third function signal,

Referring to table 3, when the detection circuit 26 detects of activation of the button 223a, the third function circuit 253 generates the third function K of the third function group, which is later conveyed via the signal output interface 27 to the signal transmitter 231. Thus, the signal transmitter 231 transmits the third function signal S3 along the third direction I3 to the electronic device (not shown), thereby performing the predetermined task representing the third function O.

TABLE 3
the third function group [with ref: to FIG. 4C]

| | Element No | | | | | | | |
|---|---|---|---|---|---|---|---|---|
| | 221a | 221b | 221c | 221d | 222a | 222b | 222c | 222d |
| 3^{rd}. | F | G | H | E | B | C | D | A |
| function | | | | | | | | |

| | Element No | | | | | | | | |
|---|---|---|---|---|---|---|---|---|---|
| | 223a | 223b | 223c | 223d | 223e | 223f | 223g | 223h | 223i |
| 3^{rd} | K | N | Q | J | M | P | I | L | O |
| function | | | | | | | | | |

To those persons skilled in the art, it is easily understand that the user is in a habit of pressing the button at the right corner (if he or she is not left-handed) of the remote control unit so as to switch On/Off the electronic device. As illustrated in FIG. 4A, since the signal transmitter 231 extends along the first direction I1 for transmitting the first function signal S1, the button 223c at the right corner represents the first function K according to table 1. In other words, pressing on the button 223c includes the action of Turn-On and Turn-Off the power source of the electronic device.

In FIG. 4B, since the signal transmitter 231 extends in the second direction I2 for transmitting the second function signal S2, the button 223i at the right corner represents the second function K according to table 2. In other words, pressing on the button 223i includes the action of Turn-On and Turn-Off the power source of the electronic device.

In FIG. 4C, since the signal transmitter 231 extends in the third direction I3 for transmitting the third function signal S3, the button 223a at the right corner represents the third function K according to table 3. In other words, pressing on the button 223a includes the action of Turn-On and Turn-Off the power source of the electronic device.

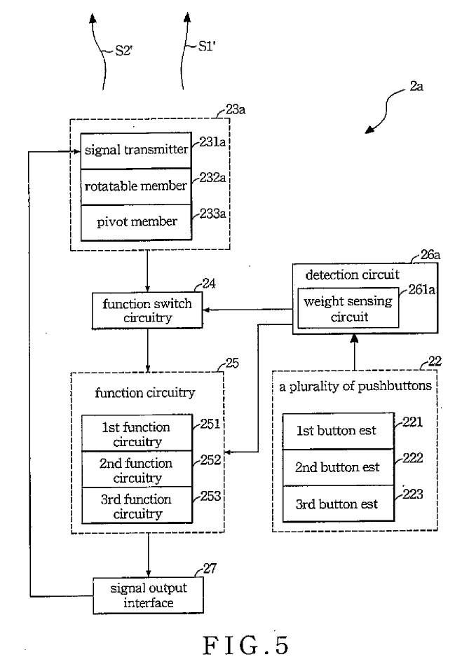

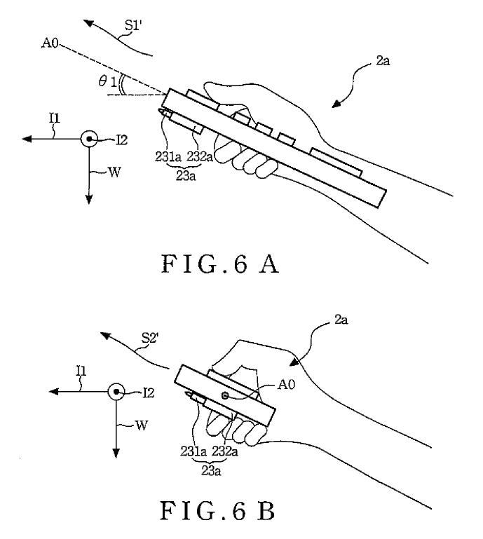

FIG. 5 is a block diagram illustrating the elements constituting the second embodiment of the remote control unit 2a of the present invention. FIGS. 6A and 6B respectively show how the second embodiment of the remote control unit 2a of the present invention transmits different function signals when the same is gripped by the user in different ways.

As illustrated, the signal unit 23a is mounted rotatably on the housing 21, and includes a signal transmitter 231a, a rotatable member 232a and a pivot member 233a. The signal transmitter 231a is disposed on the rotatable member 232a, which, in turn, is attached to the housing 21 via the pivot member 233a in such a manner that the rotatable member 232a is pivotable about the pivot member 233a so as to dispose the signal transmitter 231a to extend along the first direction I1, the second direction I2 and the third direction I3. The detection circuit 26a is coupled electrically to the pushbuttons 22, the function switch circuitry 24 and the function circuitry 25.

In this embodiment, the housing 21 (see FIG. 2) defines a longitudinal axis A0. The detection circuit 26a is capable of detecting whether the longitudinal axis A0 extends along the first direction I1 or the second direction I2. Note that the first direction I1 is perpendicular to the second direction I2. When the user grips the remote control unit 2a of the present invention as shown in FIG. 6A, the detection circuit 26a is capable of detecting that the longitudinal axis A0 extends along the first direction I1. Under this condition, the function switch circuitry 24 switches the function circuitry 25 to the first function circuit 251.

When the detection circuit 26a detects of activation of any one of the buttons 221a-221d, 222a-222d, 223a - - - 223i, the first function circuit 251 generates the first function signal of the first function group and that the first function signal is conveyed to the signal transmitter 231a via the signal output interface 27. The signal transmitter 231a transmits the first function signal S1′ along the first direction I1. If the first function signal S1′ possesses the directive properties, the first function signal S1′ can be altered by turning the rotatable member 232a about the pivot member 233a. In case the first function signal S1, does not possess the directive properties, the aforementioned alteration is not required.

When the user grips the remote control unit 2a of the present invention as shown in FIG. 6B (the longitudinal axis extends in the horizontal direction), the detection circuit 26a is capable of detecting that the longitudinal axis A0 extends along the second direction I2. Under this condition, the function switch circuitry 24 switches the function circuitry 25 to the second function circuit 252. When the detection circuit 26a detects of activation of any one of the buttons 221a-221d, 222a-222d, 223a - - - 223i, the second function circuit 252 generates the second function signal of the second function group and that the second function signal is conveyed to the signal transmitter 231a via the signal output interface 27. The signal transmitter 231a transmits the second function signal S2′ along the second direction I2. In the similar manner, if the second function signal S2′ possesses the directive properties, the second function signal S2′ can be altered by turning the rotatable member 232a about the pivot member 233a. In case the second function signal S2′ does not possess the directive properties, the aforementioned alteration is not required.

Moreover, in this embodiment, the housing is constructed to be ergonomic so as to conform with the holding habits of the user to determine whether the longitudinal axis A0 extends along the first and second directions I1, I2. Since the detection circuit 26a includes a gravity sensing circuit 261a, which is used for detecting whether the longitudinal axis A0 extends parallel to or perpendicular to a gravity direction W.

When the user grips the remote control unit 2a such that the housing 21 extends in the vertical direction, the gravity sensing circuit 261a is able to detect that the longitudinal axis A0 extends parallel to the a gravity direction W and the detection circuit 26a determines that the longitudinal axis A0 extends along the first direction I1. When the user grips the remote control unit 2a such that the housing 21 extends in the horizontal direction, the gravity sensing circuit 261a is able to detect that the longitudinal axis A0 extends perpendicular to the gravity direction W and the detection circuit 26a determines that the longitudinal axis A0 extends along the second direction I2.

Referring to FIG. 6A, the first direction I1 and the second direction I2 cooperatively constitute a reference horizontal plane (not shown). According to ergonomics, when the user grips the housing 21 of the remote control unit 2a along its longitudinal length such that when the longitudinal axis A0 cooperates with the reference horizontal plane to form an acute angle θ1 therebetween, the detection circuit 26a is capable of detecting the longitudinal axis A0 extending parallel to the gravity direction W and that the longitudinal axis A0 extends along the first direction I1.

Referring to FIG. 6B, according to ergonomics, when the user grips the housing 21 of the remote control unit 2a along its longitudinal length such that when the longitudinal axis A0 is generally parallel to the reference horizontal plane, the detection circuit 26a is capable of detecting the longitudinal axis A0 extends perpendicular to the gravity direction W and that the longitudinal axis A0 extends along the second direction I2.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A remote control unit comprising:
a housing;
at least one pushbutton disposed on said housing;
a signal transmitter mounted rotatably on said housing and adapted to be switched between first and second positions;
a detection circuit coupled electrically to said pushbutton and said signal transmitter for detecting activation of said pushbutton, said detection circuit activates said signal transmitter to output a function signal;
wherein, said signal transmitter generates and transmits a first function signal when said signal transmitter is disposed at said first position and a second function signal different from said first function signal when said signal transmitter is disposed at said second position.

2. The remote control unit according to claim 1, further comprising a rotatable member that holds said signal transmitter thereon, that is mounted on said housing and that is capable of rotating between said first and second positions.

3. The remote control unit according to claim 1, further comprising a function circuitry coupled electrically to said detection circuit for defining a first function group for said first function signal when said signal transmitter is at said first position and a second function group for said second function signal when said signal transmitter is at said second position.

4. The remote control unit according to claim 3, wherein said function circuitry includes a first function circuit and a second function circuit respectively defining said first function group and a second function group.

5. The remote control unit according to claim 3, further comprising a function switch circuitry coupled to said signal transmitter, said function circuitry and said detection circuit in such a manner that when said signal transmitter is switched between said first position and second position, said function switch circuitry is switched into said first function group and said second function group, respectively.

6. The remote control unit according to claim 3, further comprising a signal output interface coupled to said function circuitry and said signal transmitter, upon detecting activation of said pushbutton by said detection circuit and after defining a respective one of said first and second function groups by said function circuitry, said function signal being transmitted to said signal transmitter for outputting therefrom.

7. The remote control unit according to claim 1, wherein said first function signal is transmitted along a first direction when said signal transmitter is disposed at said first position and said second function signal is transmitted along a second direction when said signal transmitter is disposed at said second position.

8. The remote control unit according to claim 7, wherein said first direction is perpendicular to said second direction.

9. A remote control unit comprising:
a housing defining a longitudinal axis;
at least one pushbutton disposed on said housing and capable of determining a first function signal and a second function signal different from said first function signal;
a signal transmitter mounted on said housing and capable of optionally outputting said first and second function signals upon activation of said pushbutton;
a detection circuit coupled electrically to said pushbutton and said signal transmitter for detecting said longitudinal axis whether said longitudinal axis extends in a first direction or a second direction;
wherein, said detection circuit activates said signal transmitter to output said first function signal upon detecting said longitudinal axis extends in said first direction and said detection circuit activates said signal transmitter to output said second function signal upon detecting said longitudinal axis extends in said second direction.

10. The remote control unit according to claim 9, wherein said detection circuit includes a gravity sensing circuit such that when said longitudinal axis cooperates with a reference horizontal plane to form an angle therebetween, said gravity sensing circuit capable of detecting said longitudinal axis extending parallel to a gravity direction.

11. The remote control unit according to claim 10, wherein said reference horizontal plane is composed of a first direction and a second direction.

12. The remote control unit according to claim 10, wherein upon detecting by said gravity sensing circuit that said longitudinal axis extends parallel to said gravity direction, said detection circuit defining said longitudinal axis extending along said first direction and upon detecting by said gravity sensing circuit that said longitudinal axis extends perpendicular to said gravity direction, said detection circuit defining that said longitudinal axis extends along said second direction.

13. The remote control unit according to claim 9, wherein said signal transmitter is mounted rotatably on said housing and adapted to be switched between a first position and a second position different from said first position such that when said detection circuit detecting said signal transmitter being disposed at said first position, said detection circuit defining said longitudinal axis extending along said first direction and when said detection circuit detecting said signal transmitter being disposed at said second position, said detection circuit defining said longitudinal axis extending along said second direction.

14. The remote control unit according to claim 9, further comprising a rotatable member that holds said signal transmitter thereon and that is mounted rotatably on said housing.

15. The remote control unit according to claim 9, wherein said first direction is perpendicular to said second direction.
